(19) United States
(12) Patent Application Publication
(10) Pub. No.: US 2024/0402951 A1
(43) Pub. Date: Dec. 5, 2024

(54) IMAGE FORMATION APPARATUS, CONTROL METHOD FOR THE SAME, AND STORAGE MEDIUM

(71) Applicant: CANON KABUSHIKI KAISHA, Tokyo (JP)

(72) Inventor: TAKAHIRO MURATA, Kanagawa (JP)

(21) Appl. No.: 18/680,416

(22) Filed: May 31, 2024

(30) Foreign Application Priority Data
Jun. 1, 2023 (JP) 2023-091219
Apr. 19, 2024 (JP) 2024-068639

(51) Int. Cl. G06F 3/12

(52) U.S. Cl. CPC G06F 3/1204; G06F 3/1239; G06F 3/1288

(57) ABSTRACT

Provided is an image formation apparatus subjected to being set as a target of a service in which use of an apparatus main body of the image formation apparatus and a consumable product to be used for printing is made available to a user for a specific sum of money, the consumable product including up to a predetermined number of printed sheets. Processing for providing the service is executed in the image formation apparatus based on contract information of the service which is received from a management server configured to manage the service in accordance with conclusion of a contract of the service which is made after the image formation apparatus is purchased by the user.

### BACKGROUND

### Field

The present disclosure relates to an image formation apparatus, a control method for the image formation apparatus, and a storage medium.

### Description of the Related Art

A plurality of modes have been developed for a flat rate service in which an image formation apparatus is used at a flat rate. For example, a main body inclusive flat rate service, a consumable product flat rate service, and the like have been widely offered.

The main body inclusive flat rate service is a flat rate service in which use of an apparatus main body of the image formation apparatus and a consumable product to be used for printing is made available for a flat rate to a user. In addition, the consumable product flat rate service is a flat rate service in which use of only a consumable product to be used for printing is made available for a flat rate to a user who already owns the image formation apparatus.

In such a flat rate service, in general, after a service use contract is completed, a product set as a target of the service is provided from a contract source, and a user starts to use the product.

When the service is started, the contract source performs additional registration of a management account of the image formation apparatus on a management server side, and at the same time, also performs registration of a consumable product the use of which is to be started and initialization thereof. From then on, the management server sequentially communicates with the image formation apparatus to perform management of the flat rate service and delivery of a new consumable product.

Japanese Patent Laid-Open No. 2017-54155 proposes a technique with which communication with the management server is established in advance, and a state of a consumable product is sent to the management server together with identification information of the image formation apparatus, so that it becomes possible to accurately grasp a triggering situation for shipping the consumable product.

According to Japanese Patent Laid-Open No. 2017-54155, after a product such as an image formation apparatus or a consumable product purchased by a user is set up and started to be used, installation of a flat rate service for the product has not been considered.

### SUMMARY

Various embodiments of the present disclosure provide a mechanism with which it is possible to switch an image formation apparatus which has been installed in an outright sales format and has already been used into a flat rate service and to use the image formation apparatus under the flat rate service.

According to one embodiment of the present disclosure, there is provided an image formation apparatus subjected to being set as a target of a service in which use of an apparatus main body of the image formation apparatus and a consumable product to be used for printing is made available to a user for a specific sum of money, the consumable product to include up to a predetermined number of printed sheets. Processing for providing the service is executed in the image formation apparatus based on contract information of the service which is received from a management server configured to manage the service in accordance with conclusion of a contract of the service which is made after the image formation apparatus is purchased by the user.

Further features of the present disclosure will become apparent from the following description of exemplary embodiments with reference to the attached drawings.

### BRIEF DESCRIPTION OF THE DRAWINGS

FIG. 1 illustrates a configuration of an image processing system representing the present embodiment.

FIG. 2 illustrates a sequence up to making a contract of a flat rate service in the image processing system of the present embodiment.

FIG. 3 illustrates a flowchart of request determination processing executed by an image formation apparatus of the present embodiment.

FIG. 4 illustrates a flowchart of flat rate service validity determination processing executed by a management server of the present embodiment.

FIG. 5 illustrates a notification screen image for displaying that it is possible to subscribe a flat rate service of the present embodiment.

FIG. 6 illustrates an input screen image for inputting information used for a flat rate service installation estimate of the present embodiment.

FIG. 7A illustrates a screen image for displaying a flat rate service estimate result, and FIG. 7B illustrates a screen image for displaying a code for leading to a website where a contract of the flat rate service is to be made.

FIG. 8 illustrates a flowchart representing flat rate service estimate determination processing executed by the management server of the present embodiment.

FIG. 9 illustrates a hardware configuration of a host terminal of the present embodiment.

### DESCRIPTION OF THE EMBODIMENTS

Hereinafter, some embodiments of the present disclosure will be described in detail. It is noted that components described in the below description of embodiments represent modes that are provided as examples of the present disclosure, and a scope of the present invention is not to be limited to only those modes. In addition, components and processes in correspondence with respective embodiments are assigned with identical reference identifiers, and repeated descriptions of the components and processes in correspondence with the respective embodiments will be omitted.

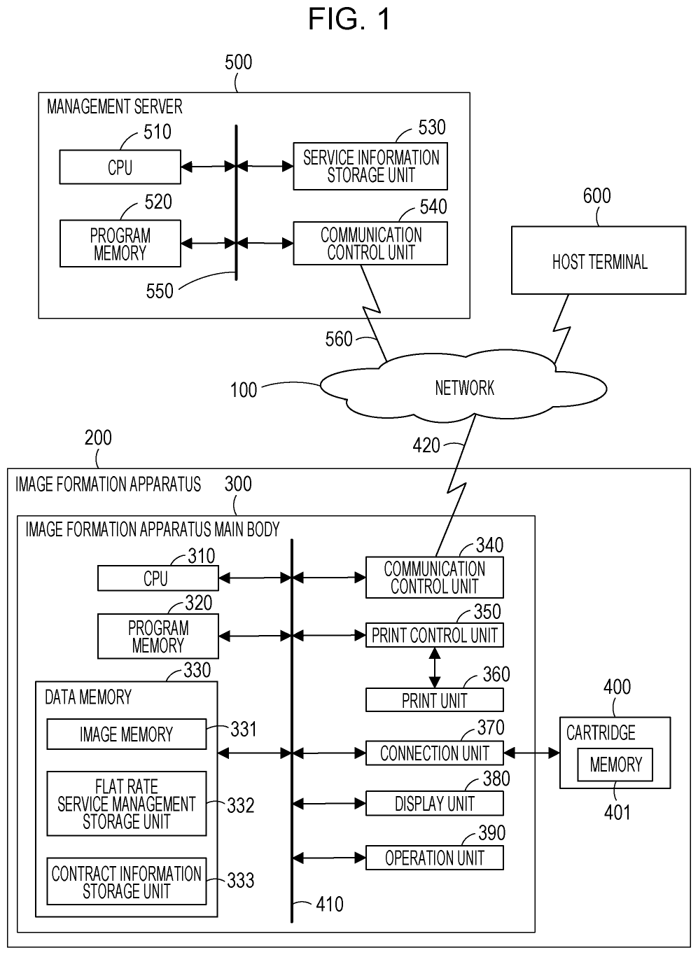

FIG. 1 illustrates an example of a configuration of an image processing system representing an embodiment of the present disclosure.

The image processing system of the present embodiment includes an image formation apparatus 200, a management server 500, and a host terminal 600, which are communicable via a network 100.

A description will be provided next regarding control of the image formation apparatus 200 and the management server 500 configured to manage a flat rate service when the image formation apparatus 200 which has been installed in an outright sales format in an initial installation period is switched into the flat rate service.

It is noted that the flat rate service in the present embodiment allows a user to perform printing up to a predetermined number of printed sheets by paying a specific sum of money. A recording material such as ink is automatically delivered to a point specified by the user. A plurality of plans may be prepared in one flat rate service, and a predetermined number of printed sheets and a value of the specific sum of money may be set for each plan. For example, a plan with which printing can be performed up to 100 sheets per month at a rate of 1,000 Japanese Yen per month and a plan with which printing can be performed up to 300 sheets per month at a rate of 2,000 Japanese Yen per month may be prepared, and the user can choose any of the plans. In addition, when the number of printed sheets has reached a higher limit of the number of printed sheets for the month in the contracted plan, printing may be disabled. Alternatively, when the number of printed sheets has exceeded the higher limit of the number of printed sheets for the month, a predetermined sum of money may be additionally charged per sheet. Alternatively, when the number of printed sheets has exceeded the higher limit of the number of printed sheets for the month, the plan may be automatically changed. For example, such a configuration may be conceivable that when the number of printed sheets has exceeded 100 sheets in the above-described 1,000 Japanese Yen plan per month, the plan is changed to the 2,000 Japanese Yen plan per month. In addition, instead of a monthly contract, at timing at which the user desires to increase the number of printed sheets, the user may pay a specific sum of money for a predetermined number of printed sheets, and printing of the predetermined number of printed sheets may be additionally enabled.

The flat rate service of the present embodiment includes a main body inclusive flat rate service and a consumable product flat rate service. The main body inclusive flat rate service is a service in which use of an apparatus main body of the image formation apparatus and a recording material to be used for printing is made available by paying a specific sum of money. The consumable product flat rate service is a service in which use of only the recording material to be used for printing is made available by paying a specific sum of money. For the image formation apparatus, an image formation apparatus purchased by the user, that is, an image formation apparatus owned by the user is used.

First, the image formation apparatus 200 will be described.

The image formation apparatus 200 includes an image formation apparatus main body 300 configured to perform a print operation using a recording material, and a cartridge 400 which can be mounted to the image formation apparatus main body 300 and is filled with ink used as the recording material. Herein, an example of using ink which is used as the recording material is illustrated, but the recording material may be toner or the like. In addition, in the present embodiment, the recording material that fills the cartridge is described, but is not limited to this. For example, a configuration may be adopted where the image formation apparatus main body 300 includes an ink tank, and the user manually pours ink from an ink bottle filled with ink into the ink tank to replenish the ink tank. In this case, instead of the cartridge, the ink bottle is delivered to the user.

The image formation apparatus main body 300 includes a central processing unit (CPU) 310, a program memory 320, a data memory 330, a communication control unit 340, a print control unit 350, a print unit 360, a connection unit 370, a display unit 380, an operation unit 390, a CPU bus 410, and the like.

The CPU 310 is a system control unit and is configured to control an entirety of the image formation apparatus 200.

The program memory 320 stores a control program executed by the CPU 310, and a program such as an embedded operating system (OS).

The data memory 330 includes an image memory 331, a flat rate service management storage unit 332, and a contract information storage unit 333. In addition, the data memory 330 stores a program control variable and the like, and is provided with buffer areas for various operations which are used at the time of processing by the print control unit 350.

The image memory 331 stores image data processed by an image processing unit which is not illustrated in the drawing.

The flat rate service management storage unit 332 holds, as management information related to the flat rate service, for example, a uniform resource locator (URL) to the management server 500, a flat rate service validity determination request execution flag, date and time of the most recently executed flat rate service validity determination, cartridge information, and printing information. Herein, the cartridge information includes information such as a serial number of a mounted cartridge for each color, information on a use-by date or a day on which two years would pass since starting date and time of the use, and the like. In addition, the printing information includes a counter configured to accumulate the number of sheets printed by the image formation apparatus 200 for each month, and the like.

The contract information storage unit 333 holds contract information of the flat rate service which is received by the image formation apparatus main body 300 through the communication control unit 340. A state held by the contract information storage unit 333 in the present embodiment is any of states including a flat rate service no contract state, a main body inclusive flat rate service contracted and standby state, a consumable product flat rate service contracted and standby state, a main body inclusive flat rate service contracted state, and a consumable product flat rate service contracted state.

When the image formation apparatus is installed in the outright sales format, the flat rate service no contract state is held in the contract information storage unit 333. In the flat rate service no contract state, a commercially available cartridge can be used. Use of a cartridge exclusive to the main body inclusive flat rate service or a cartridge exclusive to the consumable product flat rate service is controlled to be unusable. Specifically, when the cartridge exclusive to the main body inclusive flat rate service or the cartridge exclusive to the consumable product flat rate service is mounted, the image formation apparatus 200 controls the print unit 360 so as not to perform a print operation.

The main body inclusive flat rate service contracted and standby state and the consumable product flat rate service contracted and standby state indicate that the corresponding flat rate service has already been contracted but the service is not yet started.

In the main body inclusive flat rate service contracted state or the consumable product flat rate service contracted state, cartridges exclusive to the respective services can be used. In the main body inclusive flat rate service contracted state, the commercially available cartridge is controlled to be unusable. Specifically, when the commercially available cartridge is mounted, the image formation apparatus 200 controls the print unit 360 so as not to perform the print operation. Similarly, in the consumable product flat rate service contracted state too, the commercially available cartridge may be controlled to be unusable.

In addition, in the main body inclusive flat rate service contracted state, only when the image formation apparatus 200 is connected to the network 100, use of the image formation apparatus 200 which includes the print operation is enabled. When the image formation apparatus 200 is not connected to the network 100, the image formation apparatus 200 controls the print unit 360 so as not to perform the print operation. In addition, the image formation apparatus 200 controls the print unit 360 so as not to perform operations other than the print operation, such as scanning, sending a facsimile (FAX), and displaying a user interface (UI). In the consumable product flat rate service contracted state, when the image formation apparatus 200 is not connected to the network 100, the image formation apparatus 200 controls the print unit 360 so as not to perform the print operation. It is noted that even when the image formation apparatus 200 is not connected to the network 100, the print unit 360 may be controlled so as to perform the print operation within a predetermined time since the connection to the network 100 has been lost. In addition, when the image formation apparatus 200 is not connected to the network 100, the print unit 360 may be controlled in a manner that the print operation in a case where the cartridge exclusive to the consumable product flat rate service is mounted is restricted, and the print operation in a case where the commercially available cartridge is mounted is allowed.

The communication control unit 340 controls data exchange with an outside via a communication line 420 or various interfaces.

The print control unit 350 obtains printing data from the image memory 331 and controls print processing via the print unit 360. The print unit 360 performs the print processing in response to a print command by the print control unit 350. At this time, the counter configured to accumulate the number of sheets among the printing information held in the flat rate service management storage unit 332 in the data memory 330 is updated. It is noted that the printing information refers to a log (hereinafter a “print record log”) in which a job mode such as copy or print, the number of printed sheets, and a print result are summarized, and corresponds to information (also referred to as operation information) indicating an amount of use of the image formation apparatus 200. It is noted that instead of the number of printed sheets, other information such as a print dimension, the number of print discharges, or the number of conveying roller rotations may be used. A printing time, an operating time, or the like may also be used. This print record log is updated in units of jobs which involve the print operation by the print control unit 350. In addition, a determination on whether or not the cartridge exclusive to the flat rate service is used is performed by the print unit 360, and a determination result is transmitted to the print control unit 350.

The connection unit 370 connects the image formation apparatus main body 300 to the cartridge 400. In addition, the connection unit 370 receives information of the cartridge 400 from a memory 401 provided in the cartridge 400 and provides the information of the cartridge 400 in response to a request for obtaining information by the print unit 360.

The display unit 380 is constituted by a light emitting diode (LED), a liquid crystal display (LCD), or the like and configured to present various information to the user.

The operation unit 390 is constituted by a display having a touch panel function or various hardware keys. Various operation screens are displayed on the display of the operation unit 390. The user can input instructions and information to the image formation apparatus main body 300 via the operation unit 390. According to the present embodiment, the display unit 380 is assumed to be constituted by the display based on the LCD and integrated with the operation unit 390.

The CPU 310, the program memory 320, the data memory 330, the communication control unit 340, the print control unit 350, the print unit 360, the connection unit 370, the display unit 380, and the operation unit 390 are mutually connected via the CPU bus 410 managed by the CPU 310.

The cartridge 400 includes the memory 401. The memory 401 records cartridge information 1 for identifying the cartridge 400, cartridge information 2 representing remaining amount information of ink, cartridge information 3 for determining whether or not the cartridge 400 is a cartridge exclusive to the flat rate service, and the like.

The cartridge information 1 is a serial number allocated when the cartridge is manufactured.

The cartridge information 2 is information related to a remaining amount of ink contained in the cartridge. The cartridge information 2 may be represented using units of volume, or may be represented by remaining amount levels segmented by a predetermined threshold.

The cartridge information 3 is information for determining whether the cartridge is a commercially purchased cartridge (hereinafter “ordinary cartridge”) or a cartridge exclusive to the flat rate service. It is noted that the cartridge information 3 may be parameters different in the cartridge exclusive to the main body inclusive flat rate service and the cartridge exclusive to the consumable product flat rate service, or may be the same parameter.

The cartridge 400 may be any cartridge which is filled with the recording material to be used for printing and replaceable by being removed from the connection unit 370. For this reason, the cartridge 400 is not limited to an ink cartridge, and may be, for example, a toner cartridge.

Next, the management server 500 will be described.

The management server 500 is an information processing apparatus which includes a CPU 510, a program memory 520, a service information storage unit 530, a communication control unit 540, a CPU bus 550, and the like.

The CPU 510 is a system control unit and configured to control an entirety of the management server 500.

The program memory 520 stores a control program executed by the CPU 510, a program of an embedded operating system (OS), or the like.

A list of products set as targets of the flat rate service, information of a cartridge that can guarantee a quality for each of the products, a threshold for the number of printed sheets per month for each of the products, and the like are saved in the service information storage unit 530. In addition, the service information storage unit 530 holds information of a user who has made a contract of the flat rate service, identification information (for example, a serial number or the like) of the image formation apparatus used in the flat rate service, printing information collected from the print record log sent from the image formation apparatus 200, and the like.

The communication control unit 540 controls data exchange with the outside via a communication line 560.

The above-described components 510 to 540 are mutually connected via the CPU bus 550 managed by the CPU 510.

It is noted that the management server 500 may be any management server realized by a single computer or realized by a plurality of computers. For example, the management server 500 may be configured by being realized by using a technique of cloud computing.

Next, the host terminal 600 will be described.

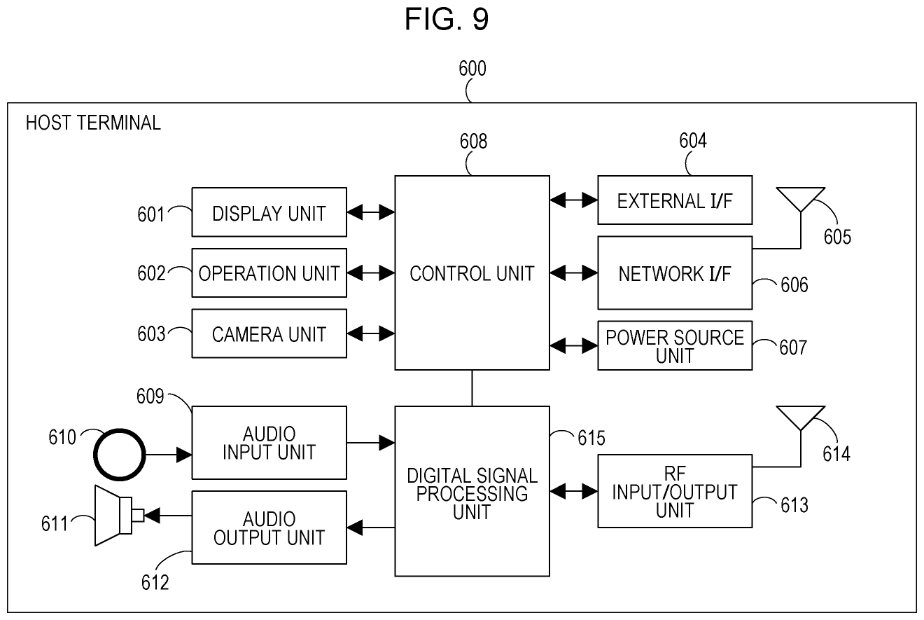

The host terminal 600 is a communication device which is connected to a network and can communicate with the management server 500. The communication device mentioned herein is, for example, a smartphone, a tablet type computer, a personal computer (PC), or the like. A configuration in which a smartphone is used as the host terminal 600 will be exemplified in FIG. 9.

FIG. 9 illustrates an example of a hardware configuration related to the host terminal 600 of the present embodiment.

In the host terminal 600, a display unit 601 performs display output of information to the user.

An operation unit 602 is a portion configured for the user to input operation information to the host terminal 600. The operation unit 602 is constituted, for example, by a touch panel, a hardware key, or the like.

A camera unit 603 generates image data by shooting a subject. The image data shot by the camera unit 603 is stored in a flash read-only memory (ROM) included in the control unit 608 or external media such as an SD card.

An external interface (I/F) 604 provides an interface with an external apparatus and is constituted by a communication interface circuit, a Micro USB terminal, or the like.

A network I/F 606 includes an antenna 605 for communication with a wireless local area network (LAN).

The network I/F 606 is constituted so as to enable network connection by wireless communication via a router, for example.

A power source unit 607 generates and supplies power used for each block based on a battery power source.

A control unit 608 is a main part configured to realize a function of the host terminal 600 and is constituted by a CPU, an electrically erasable programmable read-only memory (EEPROM), a flash ROM, a static random-access memory (SRAM), or the like which is not illustrated in the drawing. The CPU of the control unit 608 realizes various control by reading out and executing a program stored in the flash ROM or the like. For example, the control unit 608 can analyze image data of a one-dimensional or two-dimensional code (for example, a QR code (registered trademark)) shot by the camera unit 603 to obtain information. In addition, the control unit 608 can execute a web browser program to access the management server 500 or the like.

An audio input unit 609 converts an analog voice signal input from a microphone 610 into a digital signal. An audio output unit 612 converts a received digital voice signal into an analog voice signal to be output from a speaker 611. A radio frequency (RF) input/output unit 613 performs high frequency transmission/reception via an antenna 614. A digital signal processing unit 615 is connected to each of the audio input unit 609 to which the microphone 610 is connected, the audio output unit 612 to which the speaker 611 is connected, and the RF input/output unit 613 to which the antenna 614 is connected. The digital signal processing unit 615 performs encoding of a digital voice signal, decoding into a digital voice signal, and the like.

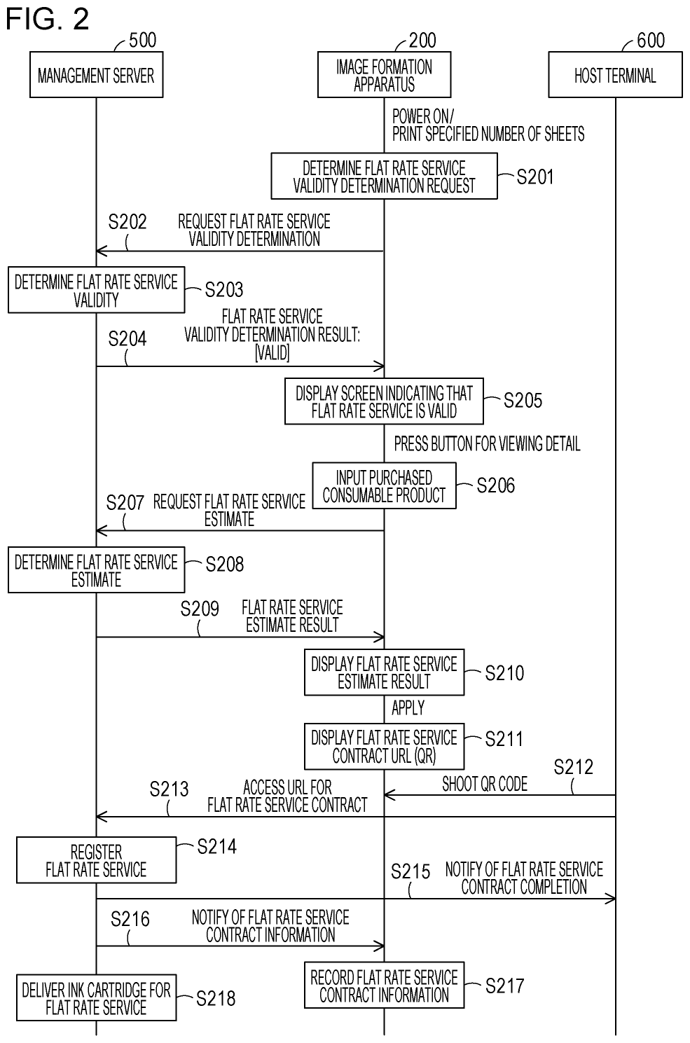

Next, a sequence leading up to making a contract for using a flat rate service of the present embodiment will be described with reference to FIG. 2.

FIG. 2 illustrates an example of a sequence up to making a contract of a flat rate service in the image processing system of the present embodiment. It is noted that processing of the management server 500 in this drawing is realized when the CPU 510 reads out and executes a program stored in the program memory 520. In addition, processing of the image formation apparatus 200 is realized when the CPU 310 reads out and executes a program stored in the program memory 320. In addition, processing of the host terminal 600 is realized when a CPU which is not illustrated in the drawing of the control unit 608 in the host terminal 600 reads out and executes a program stored in a flash ROM or the like. It is noted that “S” in the drawing represents each step.

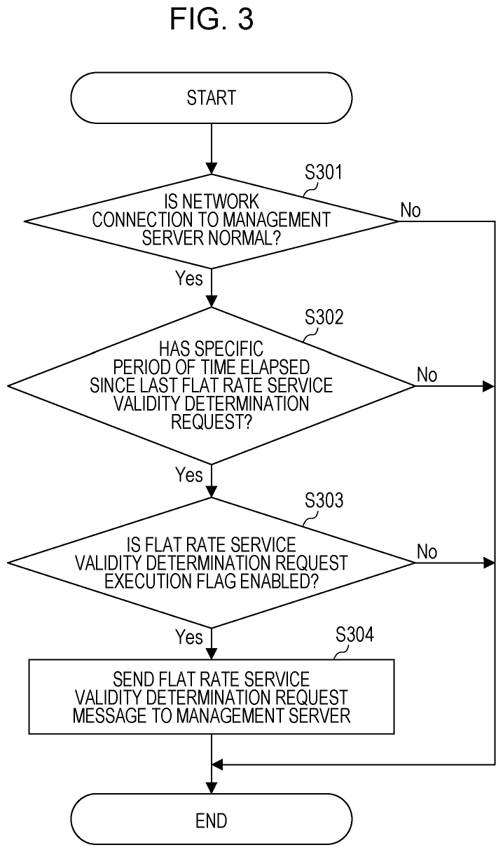

In S201, the image formation apparatus 200 determines whether or not the management server 500 functioning as a flat rate service management server is requested to perform a flat rate service validity determination upon a triggering situation illustrated below which occurs in the image formation apparatus 200. Examples of the triggering situation in the present step in the present embodiment include a triggering situation in which the image formation apparatus is activated by a power button, a triggering situation in which any of cartridges is replaced, a triggering situation in which the number of printed sheets has exceeded a threshold (for example, 300 sheets), and a triggering situation in which update of firmware is completed. It is however noted that the triggering situations are not limited to these. In addition, instead of executing the processing for the determination immediately after these triggering situations, for example, the processing for the determination is set to be executed after a specific period of time (for example, after approximately 30 to 60 minutes) from these triggering situations. This is because a state is established where much of hardware such as the CPU 310, the program memory 320, and the communication control unit 340 and software resources is used at timing immediately after any of the triggering situations. In this state, in general, processes are originally to be executed to respond to requests from the user by priority. To avoid disturbance on those processes, the processing for the determination is executed in a triggering situation in which the CPU 310 has processed timer monitoring or an event in which no operation state continues by the apparatus, or the like. It is however noted that the above-described execution timing after the specific period of time is not limited to timing after approximately 30 to 60 minutes from these triggering situations. Note that processing (request determination processing) of determining whether or not the above-described flat rate service validity determination in S201 is requested will be described with reference to FIG. 3 illustrated below.

In S201 described above, when it is determined that the management server 500 is not requested to perform the flat rate service validity determination, the image formation apparatus 200 waits for a next triggering situation.

On the other hand, when it is determined that the management server 500 is requested to perform the flat rate service validity determination, in S202, the image formation apparatus 200 sends, to the management server 500, a message for a request to perform the flat rate service validity determination.

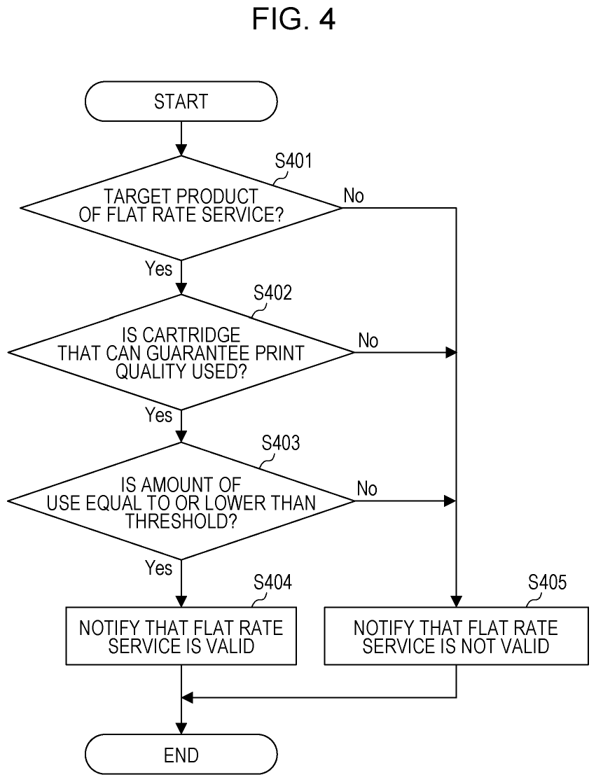

When the message of the flat rate service validity determination request is received from the image formation apparatus 200, in S203, the management server 500 performs the flat rate service validity determination. The flat rate service validity determination will be described with reference to FIG. 4 illustrated below. It is noted that when the user installs the image formation apparatus in the outright sales format, an approach is taken to prompt the user to establish network connection in an early stage by providing a configuration to display a notification indicating that transition to the flat rate service (the main body inclusive flat rate service or the consumable product flat rate service) is possible on the display unit 380 as an announcement in a final stage at the time of the setup, informing the user by way of paper media together with operation manuals, or the like. In addition, this notification may be displayed on the display unit 380 on a regular basis. Furthermore, the user may be prompted to input a price for the purchase of the image formation apparatus (such as a price on a receipt) from a screen of this notification.

When the image formation apparatus 200 is connected to the network to communicate with the management server 500 via the Internet, a product serial number (information with which it is possible to identify a model and an apparatus) of the image formation apparatus 200, a state of the image formation apparatus 200, an operation state such as the number of printed sheets, and the like can be stored in the management server 500 to be managed. Thus, it becomes possible for the management server 500 to appropriately perform the determination in the flat rate service validity determination.

When it is determined in the flat rate service validity determination in S203 described above that the flat rate service validity determination result is invalid, the management server 500 sends a response message indicating “invalid” (not illustrated) to the image formation apparatus 200. When the response message indicating that the flat rate service validity determination result is invalid is received, the image formation apparatus 200 ends the processing without performing any display (not illustrated).

On the other hand, when it is determined in the flat rate service validity determination in S203 that the flat rate service validity determination result is valid, in S204, the management server 500 returns a response message indicating “valid” to the image formation apparatus 200.

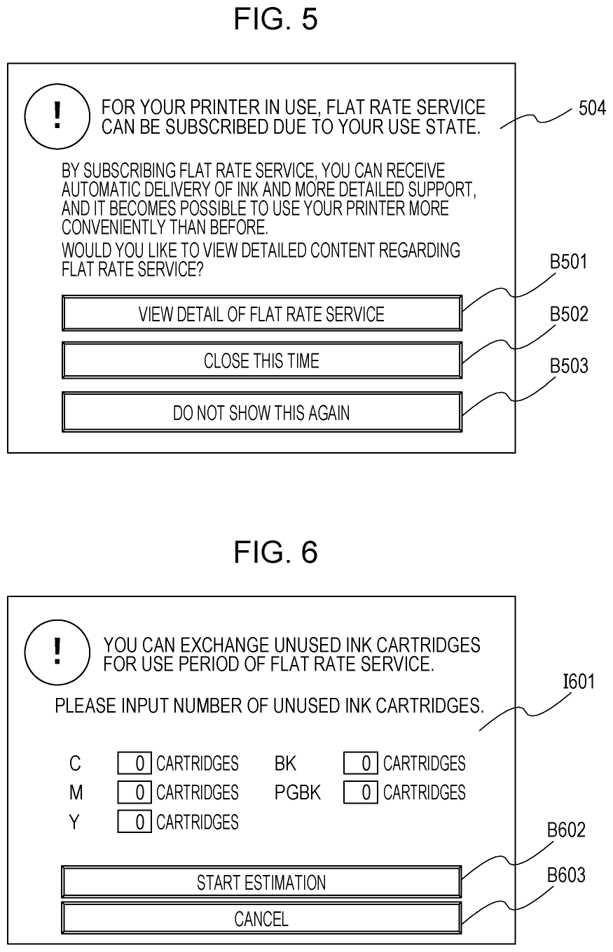

When the response message indicating that the flat rate service validity determination result is valid is received, in S205, the image formation apparatus 200 displays on the display unit 380 as an announcement that the transition to the flat rate service is possible, and causes the flow to proceed to subsequent processing. Herein, the display indicating that the transition to the flat rate service is possible will be described with reference to FIG. 5.

FIG. 5 exemplifies an image of a notification screen for displaying that the flat rate service can be subscribed. This notification screen includes a message 504 and buttons B501, B502, and B503.

The message 504 corresponds to a message for notifying that the transition to the main body inclusive flat rate service is possible due to a use state.

When the user has pressed the button B501 for viewing a detail of the flat rate service, in S206, the image formation apparatus 200 displays an input screen for inputting information used to calculate a fee for using the flat rate service on the display unit 380. The input screen displayed herein is, for example, a screen for inputting the number of unused cartridges as illustrated in FIG. 6.

When the user has pressed the button B502 for closing the screen this time, the image formation apparatus 200 closes the screen of FIG. 5 and returns to the original screen.

When the user has pressed the button B503 for not showing this again, the image formation apparatus 200 sets the flat rate service validity determination request execution flag held in the flat rate service management storage unit 332 in the program memory 320 into a disabled state so that the screen of FIG. 5 is not to be displayed thereafter. In the case of the image formation apparatus installed in the outright sales format, this flag is up as enabled from the time of the setup. When this flag is up, in other words, when this flag is enabled, the flat rate service validity determination request is issued to the management server 500. It is noted that in the case of the image formation apparatus loaned from a service provider after a use contract of the flat rate service is concluded in advance, this flag is set as disabled from the time of the setup. This flag is one of items determined in the flowchart illustrated in FIG. 3.

Herein, a screen for inputting the number of unused cartridges which is displayed in S206 described above will be described.

FIG. 6 exemplifies an image of an input screen for inputting information used for a flat rate service installation estimate. This input screen includes an input unit I601 and buttons B602 and B603.

The input unit I601 is an input unit configured to present that an unused cartridge can be exchanged for a use period of the flat rate service and to input the number of unused cartridges. It is noted that the input unit I601 may accept an input such as a serial number of an unused cartridge or the like. Furthermore, the input unit I601 may accept an input of a price on a receipt issued when the user has purchased the unused cartridge described above or the image formation apparatus main body 300.

When the user has pressed the button B602 for starting estimation, the image formation apparatus 200 causes the processing to proceed to S207.

On the other hand, when the user has pressed the button B603 for cancellation, the image formation apparatus 200 ends the processing (not illustrated).

In S207, to obtain information related to the fee for using the flat rate service, the image formation apparatus 200 sends an estimate request message to the management server 500 together with the information input in S206 described above.

When the flat rate service estimate request is received, in S208, the management server 500 performs flat rate service estimate determination processing. In this flat rate service estimate determination processing, upon transition to the flat rate service of the image formation apparatus 200, the management server 500 decides prices for the service provider to acquire the image formation apparatus 200 and the consumable product in the case of the main body inclusive flat rate service or to acquire the consumable product in the case of the consumable product flat rate service from the user. The management server 500 calculates these prices from the information input by the user in S206 described above, the stored operation information described above, and the like. Furthermore, the management server 500 calculates a result in a case where the above-described calculated price (acquisition price) is credited to the number of days for providing the flat rate service, that is, in terms of the price of the flat rate service, how long is the above-described calculated price equivalent to (for example, for how many months).

Next, in S209, the management server 500 sends the result calculated in S208 described above to the image formation apparatus 200 as an estimate result of the flat rate service.

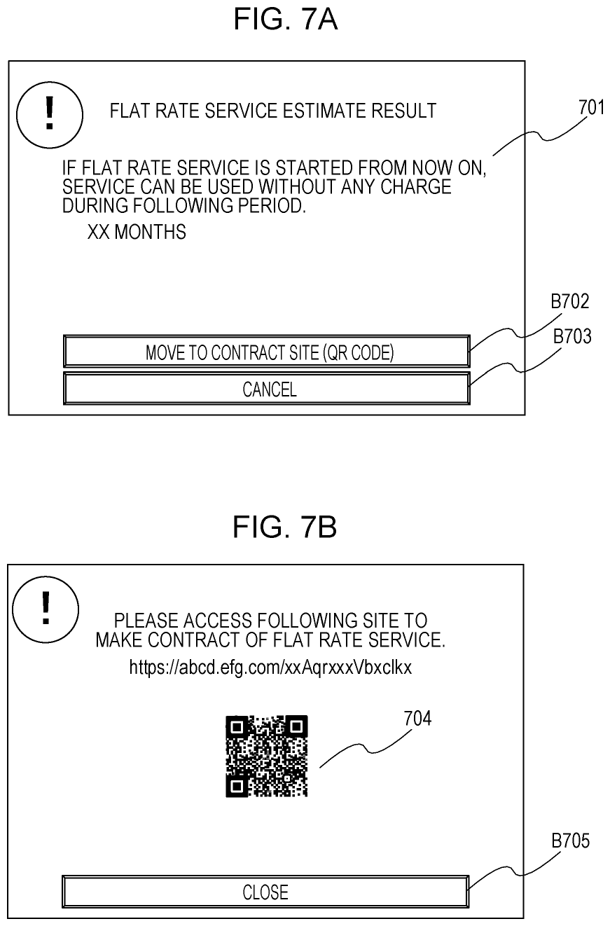

When the estimate result of the flat rate service is received, in S210, the image formation apparatus 200 displays the received estimate result of the flat rate service described above on a screen as illustrated in FIG. 7A, for example, and presents the estimate result to the user. Herein, the screen for displaying the flat rate service estimate result will be described with reference to FIG. 7A.

FIG. 7A exemplifies an image of the screen for displaying the flat rate service estimate result.

As the estimate result, this screen includes a message 701 indicating a result in a case where the acquisition price of the image formation apparatus 200 is credited to (exchanged for) the number of days for providing the flat rate service, and buttons B702 and B703. It is noted that the message 701 may be displayed in terms of a price to be paid by the user such as “year 2023, month X: JPY 0, year 2023, month Y: JPY 0, and year 2023, month Z and thereafter: JPY x”.

When the user agrees with the estimate result, the button B702 for moving to a contract site (QR code) is pressed. On the other hand, when the user does not agree with the estimate result, the button B703 for cancellation is pressed.

Herein, when the button B702 for moving to the contract site (QR code) is pressed by the user, the image formation apparatus 200 causes the processing to proceed to S211. When the cancellation button B703 is pressed by the user, the image formation apparatus 200 ends the processing (not illustrated).

In S211, the image formation apparatus 200 displays a code such as a QR code for guiding the user to a website where a contract is to be made on the display unit 380 as illustrated in FIG. 7B, for example. It is noted that herein, a two-dimensional code such as a QR code is used, but the code is not limited to this, and a one-dimensional code such as a bar code or codes in other formats may also be used.

FIG. 7B exemplifies an image of the screen for displaying the QR code for guiding the user to the website where the contract of the flat rate service is to be made.

This screen includes a QR code 704 and a close button B705.

The QR code 704 includes information used for the contract of the flat rate service, specifically, a URL (contract URL of the management server 500) for connection to the website where the contract of the flat rate service is to be made, and an identifier indicating an association with the estimate provisionally calculated in S208 described above.

When a shooting operation of the QR code is performed by the user, in S212, the host terminal 600 shoots the QR code displayed in S211 described above on the display unit 380 of the image formation apparatus 200 by using the camera unit 603, and obtains information used for the above-described flat rate service contract.

Next, in S213, the host terminal 600 uses the information obtained from the QR code in S212 described above to access the contract URL of the management server 500 from a web browser or the like of the host terminal 600.

When the contract URL is accessed, in S214, the management server 500 accepts a flat rate service registration. When the user inputs information used for the contract of the flat rate service from the web browser or the like of the host terminal 600, such as, for example, a name of a contracting party, a consumable product delivery destination address, and a payment method for the fee, in a case where it is confirmed that these pieces of information have been correctly input, the management server 500 causes the processing to proceed to S215.

In S215, the management server 500 provides a contract completion notification of the flat rate service to the host terminal 600.

Thereafter, upon conclusion of the contract, in S216, the management server 500 sends the contract information of the flat rate service to the image formation apparatus 200.

In S218, the management server 500 executes processing of arranging delivery of the cartridge for the flat rate service to the contracting party.

When the contract information of the flat rate service is received, in S217, the image formation apparatus 200 writes the above-described received contract information of the flat rate service to the contract information storage unit 333. The contract information of the flat rate service at this time is set as the main body inclusive flat rate service contracted and standby state or the consumable product flat rate service contracted and standby state. In the case of the main body inclusive flat rate service contracted and standby state or the consumable product flat rate service contracted and standby state, use of the ordinary cartridge may be permitted.

When the cartridge for the flat rate service which is delivered from the service provider by the processing in S218 described above is attached by the user as the cartridge 400 of the image formation apparatus 200, the image formation apparatus 200 updates the contract information of the flat rate service of the contract information storage unit 333 by the connection unit 370. At this time, the contract information of the flat rate service which is stored in the contract information storage unit 333 is changed from the main body inclusive flat rate service contracted and standby state or the consumable product flat rate service contracted and standby state to the main body inclusive flat rate service contracted state or the consumable product flat rate service contracted state, and provision of various services in the flat rate service is started.

It is noted that in the present embodiment, in S217, the contract information indicating the flat rate service contracted and standby state is recorded in the contract information storage unit 333. Then, when the cartridge for the flat rate service delivered in S218 is attached to the image formation apparatus 200, the contract information in the contract information storage unit 333 is updated to the flat rate service contracted state, and the provision of the flat rate service is started. However, an update method of the contract information is not limited to this. For example, in S217, the contract information indicating the flat rate service contracted state may be recorded in the contract information storage unit 333. In this case, when the contract information is received from the management server 500, the provision of the flat rate service is immediately started.

When the contract information in the contract information storage unit 333 is changed to the flat rate service contracted and standby state or the flat rate service contracted state, according to the change, the image formation apparatus 200 also changes control of the image formation apparatus 200. For example, the image formation apparatus 200 is controlled in a manner that use of the cartridge for the flat rate service, which has been restricted in a state where the contract is not yet made, is permitted. In addition, the image formation apparatus 200 is controlled in a manner that use of a commercially available cartridge, which has been permitted in a state where the contract is not yet made, is restricted. In addition, the image formation apparatus 200 is controlled in a manner that the print operation is restricted when no connection is established to the network 100. Furthermore, in the case of the main body inclusive flat rate service, the image formation apparatus is controlled in a manner that operations other than the print operation are also restricted. For example, scanning, FAX, and display of an UI are restricted. In addition, a notification related to these control changes may be displayed on the display unit 380 of the image formation apparatus 200. For example, display is performed to indicate that use of the cartridge for the flat rate service is permitted. In addition, the contract information recoded in the contract information storage unit 333 may be displayed on the display unit 380 of the image formation apparatus 200. For example, an effect is displayed that the state is the flat rate service contracted and standby state or the flat rate service contracted state. In addition, information indicating that the provision of the flat rate service is to be started may be displayed on the display unit 380. In addition, in the present embodiment, a configuration has been described in which even before the contract of the flat rate service is concluded, an operation state of the image formation apparatus 200 is sent to the management server 500, but is not limited to this. Such a setting may be made that when the image formation apparatus 200 changes the contract information in the contract information storage unit 333 to the flat rate service contracted and standby state or the flat rate service contracted state, the operation state of the image formation apparatus 200 is thereafter sent to the management server 500. Specifically, information on the number of printed sheets, a consumption amount of a consumable product such as a recording material, or a remaining amount of a consumable product in the image formation apparatus 200 may be sent to the management server 500.

Herein, the request determination processing of the flat rate service validity determination illustrated in S201 of FIG. 2 will be described in detail with reference to FIG. 3.

FIG. 3 is a flowchart illustrating an example of the request determination processing executed by the image formation apparatus 200 of the present embodiment. This processing is realized when the CPU 310 of the image formation apparatus 200 reads out a program stored in the program memory 320. When the triggering situation as described above occurs in the image formation apparatus 200, the CPU 310 of the image formation apparatus 200 starts processing in the present flowchart.

First, in S301, the CPU 310 of the image formation apparatus 200 enquires the communication control unit 340 to determine whether or not network connection to the management server 500 normally operates.

This determination is for checking whether the connection to the management server 500 can be established or not and for, at the same time, checking whether a determination result from the management server 500 can be received or not. The communication control unit 340 provides an application programming interface (API) for checking the connection to the management server 500. This API is configured by a PING response using a hostname or an IP address, or a program for connectivity test on communication between hosts based on individually created IP communication, for example.

Herein, when communication with the management server 500 has failed (S301: No), the CPU 310 ends the present flat rate service validity request determination processing.

On the other hand, when the communication with the management server 500 has been successful (S301: Yes), the CPU 310 causes the processing to proceed to S302.

In S302, the CPU 310 determines whether or not a specific period of time has elapsed since the flat rate service validity request determination executed last time. According to the present embodiment, the specific period of time is set as 30 days. Last processing execution date and time are recorded in the flat rate service management storage unit 332 in the data memory 330. A value equivalent to the elapsed time is calculated by subtracting the last processing execution date and time from a value at which current time is obtained, so that it is determined whether or not 30 days or more have elapsed since the last flat rate service validity request determination. In this determination, it is aimed to avoid a situation where the communication with the management server 500 is frequently performed, and to reduce load of the management server 500 and suppress a traffic amount of the network.

Herein, when the specific period of time has not elapsed (S302: No), the CPU 310 ends the present flat rate service validity request determination processing.

On the other hand, when the specific period of time has elapsed (S302: Yes), the CPU 310 causes the processing to proceed to S303. At this time, the CPU 310 updates date and time data recorded in the flat rate service management storage unit 332 in the data memory 330 to the current date and time.

In S303, the CPU 310 determines whether or not the flat rate service validity determination request execution flag to the management server 500 is in an enabled state. This flag is in an enabled state at a point of time upon the setup after the installation in the outright sales format, but according to the present embodiment, two triggering situations in which the flag is set to be disabled are present.

One triggering situation is a case where the screen of FIG. 5 is displayed on the display unit 380 as a result of the determination that the product is valid in the end in the previously executed processing of the flat rate service validity request to the management server 500, but the button B503 for not showing this again is pressed by the user. When this button is pressed, unless initialization of the image formation apparatus 200, resetting of a setting value, or the like is executed, the processing of requesting the management server 500 to perform the flat rate service validity determination is not executed. In addition, the other triggering situation is a triggering situation in which use of the flat rate service is started. This flag is held in the flat rate service management storage unit 332 in the data memory 330 and referred to from various programs.

Herein, when it is determined that this flat rate service validity determination request execution flag is disabled (in S303: No), the CPU 310 ends the processing in the present flowchart.

On the other hand, when it is determined that this flat rate service validity determination request execution flag is enabled (in S303: Yes), the CPU 310 causes the processing to proceed to S304. It is noted that at a point in time at which the processing proceeds to S304, a state is established where a condition is met for the image formation apparatus 200 to execute the flat rate service validity determination request to the management server 500.

In S304, the CPU 310 generates a message for requesting the management server 500 to perform the flat rate service validity determination and sends the message (corresponding to S202 in FIG. 2). According to the present embodiment, connection to the management server 500 is established by HTTPS communication using a TCP communication protocol, and data in an XML format is sent using a Post method. This XML data includes identification information of the image formation apparatus 200, information related to setup date and time, mounted cartridge information, information indicating a state of the image formation apparatus such as a counted number of printed sheets, and the like. Herein, the cartridge information includes the above-described cartridge information 1 for identifying the cartridge 400, and information such as a use-by date of each cartridge. Herein, the communication protocol and the message data format to be used are respectively set as HTTPS and XML, but communication protocols other than this and instead of the XML format, a JSON format or a comma separated CSV format may be used, for example.

Subsequently, the flat rate service validity determination processing illustrated in S203 of FIG. 2 will be described in detail with reference to FIG. 4.

FIG. 4 is a flowchart illustrating an example of the flat rate service validity determination processing executed by the management server 500 of the present embodiment. This processing is realized when the CPU 510 of the management server 500 reads out and executes a program stored in the program memory 520. When a message for a request to perform the flat rate service validity determination from the image formation apparatus 200 is received, the CPU 510 of the management server 500 starts the processing in the present flowchart. For example, an HTTP message received by the management server 500 via a network is generated as such an event that a Post method is received by a web service in the communication control unit 540, and an activated program task for executing acceptance of the flat rate service is notified of the event.

First, in S401, the CPU 510 of the management server 500 determines whether or not the product is a target product of the flat rate service. In this determination, the CPU 510 performs a search through a target product list table saved in the service information storage unit 530 or an enquiry on whether or not the product is currently a product set as a provision target of the flat rate service to perform the determination based on a product serial number that is one of the information received from the image formation apparatus 200. In addition, a method for the CPU 510 to perform the determination by enquiring another server configured to aggregate product information for determining whether or not the product is a flat rate service target product may be used instead of the above-described method.

Herein, when the product is not the target product of the flat rate service (S401: No), the CPU 510 causes the processing to proceed to S405.

In S405, the CPU 510 executes processing of notifying the image formation apparatus 200 of a message indicating that the flat rate service is not valid and ends the processing in the present flowchart.

On the other hand, when the product is the target product of the flat rate service (S401: Yes), the CPU 510 causes the processing to proceed to S402.

In S402, the CPU 510 determines whether or not a cartridge that can guarantee a print quality is used. This determination is a determination for maintaining the print quality which is important when the flat rate service is used and which leads to a continuous advantage for the user who uses the service. As described above, the service information storage unit 530 holds the target product list of the flat rate service, but also saves information of cartridges that guarantee the quality as information associated with these target products. One or a plurality of pieces of cartridge information associated with a single product represents a serial number allocated when the cartridge is manufactured, and is information equivalent to the cartridge information 1 described above according to the present embodiment. The determination is performed based on the cartridge information associated with the target product held in the service information storage unit 530 and the information of the cartridge in use which is one piece of information received from the image formation apparatus 200. In addition, whether or not a cartridge with an expired use-by date is present by referring to information related to use-by dates of the respective mounted cartridges may be one of determination processes.

Herein, when the current cartridge information is not included in the cartridge information held in the service information storage unit 530, that is, when the cartridge that can guarantee the print quality is not used (S402: No), the CPU 510 causes the processing to proceed to S405.

On the other hand, when the current cartridge information is included in the cartridge information held in the service information storage unit 530, that is, when the cartridge that can guarantee the print quality is used (S402: Yes), the CPU 510 causes the processing to proceed to S403.

In S403, the CPU 510 determines whether or not the amount of use, that is, the number of printed sheets is equal to or lower than a threshold. This determination is to guarantee the print quality similarly as in the determination for maintaining the print quality performed in S402 described above. In this determination, in order that a quality of the image formation apparatus itself does not affect the print quality, it is checked whether or not the print processing is equal to or lower than the number of printed sheets assumed by the flat rate service provider. As described above, while the target product list of the flat rate service is held in the service information storage unit 530, a threshold of the assumed number of printed sheets as information associated with these target products is held. It is noted that this threshold is a value calculated by the flat rate service provider from wear and tear assumption of a durable component such as a distal end coating part for printing which is installed to each product or a dedicated cartridge used for maintenance, and is not a numeric value which abruptly affects the print quality even when the number of printed sheets has exceeded the threshold. According to the present embodiment, the threshold is set as 300 sheets per month when the printed sheets are converted into an A4 size. Instead of the number of sheets, for example, the threshold may be represented by a printed area, or a point calculated by multiplying those values by an index number, or the like. The management server 500 performs the above-described determination based on the number of printed sheets among the information received from the image formation apparatus 200. According to the present embodiment, in the image formation apparatus 200, the number of printed sheets in the past six months is held in the flat rate service management storage unit 332 in the data memory 330, and the determination is performed on whether or not an average value thereof is equal to or lower than the threshold.

Herein, when the amount of use is not equal to or lower than the threshold (S403: No), the CPU 510 causes the processing to proceed to S405.

On the other hand, when the amount of use is equal to or lower than the threshold (S403: Yes), the CPU 510 causes the processing to proceed to S404.

In S404, the CPU 510 notifies the image formation apparatus 200 of a response message indicating that the flat rate service is valid and ends the processing in the present flowchart.

It is noted that as a response to the message for a request to perform the flat rate service validity determination which is sent from the image formation apparatus 200, the management server 500 generates an HTTP response to a Post and sets a status code 200 corresponding to a status code indicating that the processing has been normally executed in the response message. In addition, a result of the flat rate service validity determination is set in a body part of the response message. According to the present embodiment, for example, when the flat rate service is “valid”, a character string “VALID” is set, and when the flat rate service is “invalid”, a character string “INVALID” is set.

The image formation apparatus 200 which has received the response message including the result of the flat rate service validity determination displays the screen illustrated in FIG. 5 as described in step S205 above on the display unit 380, and waits in a state in which any of the button B501 to the button B503 is to be selected by the user. Thereafter, when the user presses the button B501, a message for requesting an estimate is sent from the image formation apparatus 200 to the management server 500. In the sending of the message herein, similarly as in the method described in step S304 above, after the connection to the management server 500 is established by the HTTPS communication using the TCP communication protocol, the data in the XML format is sent by using the Post method.

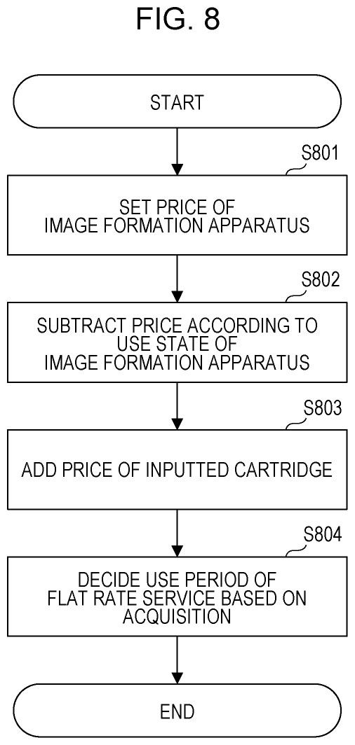

Subsequently, the flat rate service estimate determination processing illustrated in S208 of FIG. 2 will be described in detail with reference to FIG. 8.

FIG. 8 is a flowchart illustrating an example of the flat rate service estimate determination processing executed by the management server 500. This processing is realized when the CPU 510 of the management server 500 reads out and executes a program stored in the program memory 520. When a message for requesting the flat rate service estimate from the image formation apparatus 200 is received, the CPU 510 of the management server 500 starts the processing in the present flowchart.

First, in S801, the CPU 510 of the management server 500 sets a price of the image formation apparatus 200. As the price of the image formation apparatus 200, a catalog price may be used, or an average retail price in a region where the user lives or a price on a receipt issued when the user has purchased the image formation apparatus may be used.

Next, in S802, the CPU 510 performs a subtraction from the price set in S801 described above based on a use state of the image formation apparatus 200. The price to be subtracted herein is decided using one or a plurality of elements from among a period of time since the operation of the image formation apparatus 200 has started, the number of printed sheets, the amount of use of the cartridge 400, and the like based on the operation information stored in the management server 500 during a period from the start of the sales of the image formation apparatus 200 until this timing.

Next, in S803, the CPU 510 performs an addition to the price based on the number of purchased consumable products (such as the number of unused ink cartridges) which has been input by the user in S206 described above. According to the present embodiment, the price to be added herein is decided based on the number of unused cartridges. As the price of the cartridge, a catalog price may be used, or an average retail price in a region where the user lives or a price on a receipt issued when the user has purchased the cartridge may be used. It is noted that when the number of purchased consumable products has not been input by the user in S206 described above, the addition is not performed. In addition, the price at this time may be provisional, and the price may be confirmed upon dispatch of the unused cartridge. Furthermore, although not illustrated in FIG. 8 or the like, a coupon may be issued for an addition to the price to promote use of the flat rate service, and the user may be asked to input the coupon at timing in S206.

Finally, in S804, the CPU 510 decides a period during which the fee is not to be charged when the flat rate service is used by dividing the price based on acquisition of the image formation apparatus 200 and the consumable product by a monthly fee of the flat rate service. In other words, when the user changes to the flat rate service immediately after the purchase in a state where the image formation apparatus 200 is not used much, the fee is not to be charged for a long period of time after the user switches to the flat rate service. On the other hand, when the user changes to the flat rate service in a state where a considerable number of days have passed since the purchase or printing has been performed in large quantities, a period of time during which the fee is not to be charged is shortened. In addition, although not illustrated in FIG. 8 or the like, when a plurality of plans for the flat rate service are present, the user may be asked to input a plan at timing in S206 described above, which may be used to calculate the period of time during which the flat rate service can be used.

It is noted that according to the present embodiment, the flat rate service in which the main body product and the consumable product such as the cartridge or print sheets used in the main body product are usable at a flat rate has been mainly described, but the technique can be applied to the flat rate service for only the main body product. In this case, the input of the unused cartridges and the addition to the price based on the unused cartridges will be omitted.

In addition, the technique can be applied to the flat rate service for only the consumable product used in the main body product.

In this case, the estimation of the acquisition price of the image formation apparatus will be omitted, and only the price of the unused cartridge is exchanged for the use period of the flat rate service.

In accordance with the embodiment described above, by controlling each apparatus which constitutes the image processing system, it becomes possible to switch the apparatus which has been purchased as the product and already used into the flat rate service even after the purchase and to use the apparatus. By installing the flat rate service, the user can enjoy additional advantages such as automatic delivery of the consumable products, fast and accurate responses at the time of troubles, and lower total costs than current costs. In particular, in the main body inclusive flat rate service, the user receives a replacement of the image formation apparatus main body 300 for free at the time of malfunctioning or returns the image formation apparatus main body 300 after the end of the contract. For this reason, it is conceivable even for the user who has once purchased the image formation apparatus main body 300 to desire to switch to the main body inclusive flat rate service.

It is noted that in addition to the main body inclusive flat rate service or the consumable product flat rate service, the user can make a contract of a compensation service in which the image formation apparatus main body can be replaced for free at the time of malfunctioning. When the contract is made for the compensation service too, contract information is sent from a management server configured to manage the compensation service to the image formation apparatus 200. The image formation apparatus 200 receives the contract information indicating that the contract is made for the compensation service via the communication control unit 340. Upon and after the reception of the contract information, when a predetermined failure is detected in the image formation apparatus, the image formation apparatus 200 sends information of the predetermined failure to the management server via the communication control unit 340. The management server which has received the information of the predetermined failure executes processing for making a compensation according to content of the failure.

When the contract is not made for the main body inclusive flat rate service or the consumable product flat rate service, and the contract is made for only the compensation service, delivery of the recording material is not performed. The contract of the compensation service can be made in combination with the contract of the consumable product flat rate service. By making the contracts for the compensation service and the consumable product flat rate service in combination, while the user owns the image formation apparatus, it is possible to enjoy services equivalent to the main body inclusive flat rate service, that is, the compensation service and the delivery service of the recording material.

It is noted that states of image formation apparatuses which have been installed in the outright sales format and already used vary, and some image formation apparatuses are not in a state at a specific level or above. According to the present embodiment, when an image formation apparatus which has been installed in the outright sales format and already used is switched to the flat rate service, occurrence of such a circumstance can be avoided that the image formation apparatus is not in a state at the specific level or above and it is unable to meet a degree of satisfaction of the user who uses the flat rate service.

In addition, when the image formation apparatus which has been installed in the outright sales format and already used is switched to an apparatus inclusive flat rate service after the purchase, and the image formation apparatus is used, the provider of the flat rate service is to acquire the image formation apparatus. Up to now, in such a case, there is an issue that a technique to automatically and also appropriately estimate an acquisition price has not been proposed. According to the present embodiment, it is possible to appropriately estimate the acquisition price according to the amount of use of the image formation apparatus, and the user can switch to the flat rate service by taking into account the estimated price.

As described above, it becomes possible to appropriately switch the image formation apparatus which has been installed in the outright sales format and already used to the flat rate service and to use the image formation apparatus under the flat rate service.

It is noted that the configurations and content of the above-described various data are not limited to these, and it is needless to mention that the various data are configured by various configurations and content according to use and purposes.

One embodiment has been illustrated above, but the present disclosure can adopt an embodiment, for example, as a system, an apparatus, a method, a program, a storage medium, or the like. Specifically, the embodiment may be applied to a system constituted by a plurality of devices, or may be applied to an apparatus constituted by a single device.

In addition, it is noted that configurations obtained by combining the above-described respective embodiments all fall within the scope of the present disclosure.

### Other Embodiments

Various embodiments of the present disclosure can also be realized by processing in which a program for realizing one or more functions of the above-described embodiments is supplied to a system or an apparatus via a network or a storage medium, and one or more processors in a computer of the system or the apparatus read out and execute the program. In addition, the present disclosure can also be realized by a circuit (for example, an application specific integrated circuit (ASIC)) configured to realize one or more functions.

In addition, various embodiments of the present disclosure may be applied to a system constituted by a plurality of devices, or may be applied to an apparatus constituted by a single device.

The present invention is not limited to the above-described embodiments. Various modifications (including organic combinations of the respective embodiments) can be made based on the gist of the present invention, and embodiments of the invention are not intended to exclude those modifications from the scope of the present invention. That is, configurations obtained by combinations of the above-described embodiments and modification examples thereof are all included within the scope of the present disclosure.

According to various embodiments of the embodiments of the present disclosure, the image formation apparatus which has been installed in the outright sales format and already used can be switched to the flat rate service and used.

Various embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-091219 filed Jun. 1, 2023 and No. 2024-068639 filed Apr. 19, 2024, which are hereby incorporated by reference herein in their entirety.

What is claimed is:

1. An image formation apparatus subjected to being set as a target of a service in which use of an apparatus main body of the image formation apparatus and a consumable product to be used for printing is made available to a user for a specific sum of money, the consumable product to include up to a predetermined number of printed sheets, and the image formation apparatus comprising:
at least one memory that stores instructions; and
at least one processor that executes the instructions to perform operations comprising:
processing for providing the service is executed in the image formation apparatus based on contract information of the service which is received from a management server configured to manage the service in accordance with conclusion of a contract of the service which is made after the image formation apparatus is purchased by the user.

2. The image formation apparatus according to claim 1, wherein
the processing for providing the service is processing of recording, in the image formation apparatus, the contract information that is received, and
the contract information recorded in the image formation apparatus is displayed on a display unit of the image formation apparatus.

3. The image formation apparatus according to claim 1, wherein
the processing for providing the service is processing of controlling the image formation apparatus in a manner that the management server configured to manage the service is notified of a number of printed sheets or a remaining amount of a recording material.

4. The image formation apparatus according to claim 1, wherein
the processing for providing the service is processing of controlling the image formation apparatus in a manner that use of the image formation apparatus is restricted when the image formation apparatus is not communicable with the management server configured to manage the service.

5. The image formation apparatus according to claim 1, wherein
when it is determined based on an operation state of the image formation apparatus that provision of the service is available in the image formation apparatus, information indicating that the provision of the service is available is displayed on a display unit of the image formation apparatus.

6. The image formation apparatus according to claim 1, wherein
information related to an acquisition price of the image formation apparatus which is calculated based on an operation state of the image formation apparatus is displayed on a display unit of the image formation apparatus.

7. A control method for an image formation apparatus subjected to being set as a target of a service in which use of an apparatus main body of the image formation apparatus and a consumable product to be used for printing is made available to a user for a specific sum of money, the consumable product to include up to a predetermined number of printed sheets, and the control method comprising:
executing processing for providing the service in the image formation apparatus based on contract information of the service which is received from a management server configured to manage the service in accordance with conclusion of a contract of the service which is made after the image formation apparatus is purchased by the user.

8. A non-transitory computer-readable storage medium storing a computer program for executing a control method for an image formation apparatus subjected to being set as a target of a service in which use of an apparatus main body of the image formation apparatus and a consumable product to be used for printing is made available to a user for a specific sum of money, the consumable product to include up to a predetermined number of printed sheets, wherein
the control method includes
executing processing for providing the service in the image formation apparatus based on contract information of the service which is received from a management server configured to manage the service in accordance with conclusion of a contract of the service which is made after the image formation apparatus is purchased by the user.

9. An image formation apparatus subjected to being set as a target of a service in which an apparatus main body is replaced when the image formation apparatus malfunctions, the image formation apparatus comprising:
at least one memory that stores instructions; and
at least one processor that executes the instructions to perform operations comprising:
in accordance with conclusion of a contract of the service which is made after the image formation apparatus is purchased by a user, contract information of the service is received from a management server configured to manage the service, and
when a predetermined failure is detected in the image formation apparatus, information of the predetermined failure is sent to the management server.
